(19) United States
(12) Patent Application Publication
(10) Pub. No.: US 2012/0099735 A1
(43) Pub. Date: Apr. 26, 2012

(54) ENDOSCOPE WITH FUNCTION OF ACOUSTIC WAVE DETECTION AND VOICEPRINT COMPARISON

(75) Inventor: Yung-Hsiu Chen, Taipei (TW)

(73) Assignee: THREE-IN-ONE ENT CO., LTD

(21) Appl. No.: 13/279,277

(22) Filed: Oct. 22, 2011

(30) Foreign Application Priority Data
Oct. 22, 2010 (TW) 099136183

(51) Int. Cl. H04R 29/00

(52) U.S. Cl. 381/56

(57) ABSTRACT

The present invention provides an endoscope with function of acoustic wave detection and voiceprint comparison. The endoscope includes a flexible tube, a hand-held host and a sound receiving element. The hand-held host includes an analog-to-digital converter, a storage unit and a digital signal processor. The sound receiving element is disposed at the control module. The sound receiving element is used to convert surrounding acoustic waves to acoustic analog signals, and transmits the acoustic analog signals to the analog-to-digital converter of the hand-held host via the signal wires. The analog-to-digital converter converts the acoustic analog signals to digital signals, and transmits the digital signals to the digital signal processor for comparing the digital signals with the voiceprint data stored in the storage unit. The digital signal processor makes the comparison result shown at the display of the hand-held host.

### CROSS-REFERENCE TO RELATED APPLICATIONS

This Non-provisional application claims priority under 35 U.S.C. §119(a) on Patent Application No(s). 099136183 filed in Taiwan, Republic of China Oct. 22, 2010, the entire contents of which are hereby incorporated by reference.

### FIELD OF THE INVENTION

This invention relates to an endoscope, more particularly with function of acoustic wave detection and voiceprint comparison.

### BACKGROUND OF THE INVENTION

The invention of endoscope has significantly improved the effectiveness of viewing internal mechanism in objects. Early endoscopes were mostly composed of monitors, light sources, powers and detectors, which were large and heavy. After the development in several years, the size of the endoscope was reduced, for example, the endoscope can be provided as a hand-held device or portable device. When the size of the endoscope is reduced, it could be used widely in many fields, such as industrial or medical purposes.

People such as physicians, architects, electrical engineers, organization engineer or technicians could determine the problems in the subjects by reading the images on the screen. For example, a doctor can use the endoscope to check the diseases in digestive tracks or in colon for medical purposes, or an engineer can use the endoscope to check the problems in engine or turbine, etc.

So far, the conventional endoscope can only receive the images, but no sounds. Users cannot check the problems in subjects by sounds. For example, in an engine, if the user can hear the noise made from engine blades, it will be helpful for users to determine the abnormal point and find the exact problems in the engine.

If an operator can hear abnormal sounds when detecting respiratory tracts of a patient during his or her respiration, there might be something blocked in the respiratory tracts. Then the operator could give the related first aid to the patient. However, it is experience-needed for the operators to determine the problems from the sounds and is not easy to operate the devices for general users.

Therefore, in this invention, the applicant provides a new kind of endoscope to solve this problem by combining sound detection and voiceprint comparison techniques.

### SUMMARY OF THE INVENTION

The present invention provides an endoscope with function of acoustic wave detection and voiceprint comparison to solve the problems of the prior art.

The endoscope includes a flexible tube, a hand-held host and a sound receiving element. The hand-held host includes an analog-to-digital converter, a storage unit and a digital signal processor. The sound receiving element is disposed at the control module.

The sound receiving element is used to convert surrounding acoustic waves to acoustic analog signals, and transmits the acoustic analog signals to the analog-to-digital converter of the hand-held host via the signal wires. The analog-to-digital converter converts the acoustic analog signals to digital signals, and transmits the digital signals to the digital signal processor for comparing the digital signals with the voiceprint data stored in the storage unit. The digital signal processor makes the comparison result shown at the display of the hand-held host.

The endoscope with function of acoustic wave detection and voiceprint comparison of the present invention includes advantages as follows:

The endoscope with function of acoustic wave detection and voiceprint comparison provides the user to find out if something wrong in the object by determining the sound from the speaker, and further to fix the damaged portion.

The endoscope with function of acoustic wave detection and voiceprint comparison provides easy operating usage for the user, and further helps the user find out what the comparison result is.

These and other features, aspects and advantages of the present disclosure will become better understood with regard to the following description, appended claims and accompanying drawings.

### BRIEF DESCRIPTION OF THE DRAWINGS

FIG. 1 shows a schematic diagram of an endoscope with function of acoustic wave detection and voiceprint comparison of the present invention.

FIG. 2 shows a block diagram of an endoscope with function of acoustic wave detection and voiceprint comparison of the present invention.

### DETAILED DESCRIPTION OF THE INVENTION

For clarity of disclosure, and not by way of limitation, the detailed description of the invention is divided into the subsections that follow.

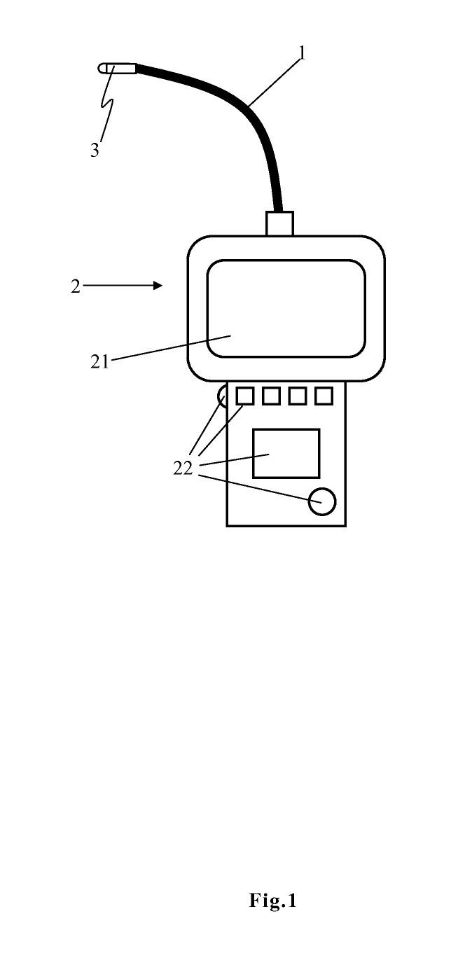

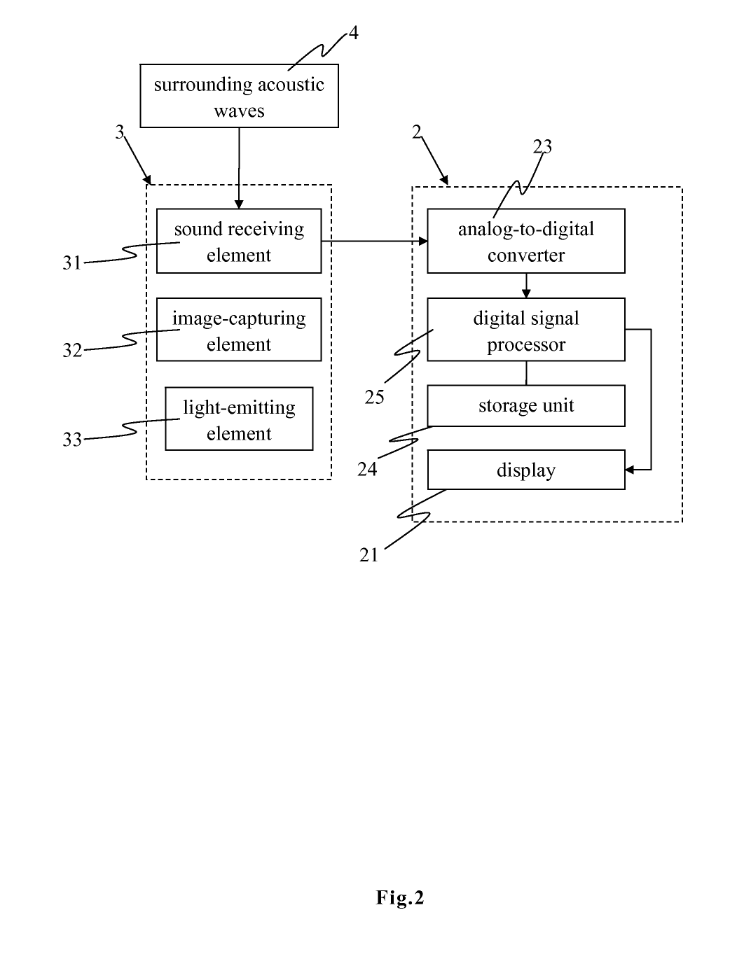

As shown in FIG. 1 and FIG. 2, FIG. 1 and FIG. 2 respectively show a schematic diagram and a block diagram of an endoscope with function of acoustic wave detection and voiceprint comparison of the present invention. The present invention provides an endoscope with function of acoustic wave detection and voiceprint comparison. The endoscope includes a flexible tube 1, a hand-held host 2 and a sound receiving element 31.

The flexible tube 1 is flexible, and is rolled into a tube by several layers of a plurality of material. A plurality of signal wires are disposed in the flexible tube 1. One end of the flexible tube 1 includes a control module 3. The control module 3 includes an image-capturing element 32 and a plurality of light-emitting elements 33.

The image-capturing element 32 can be a sensor of CCD or CMOS corresponding to optics lens for getting the image data. The light-emitting element 33 can be light-emitting diode (LED) to project light for assisting image-capturing element 32 to get the image data. The image data and control signals from the image-capturing element 32 are transmitted to the hand-held host 2 by the signal wires.

The hand-held host 2 includes an analog-to-digital converter 23, a storage unit 24 and a digital signal processor 25. The hand-held host 2 also includes a display 21, buttons 22, two communication interface ports and a memory slot. The buttons 22 also can transmit control signals by the signal wires.

A plurality of voiceprint data are stored in the storage unit 24. The voiceprint data is a kind of digital sound spectrum with amplitude and waveform. The voiceprint data stored are normal sample sounds, such as the sound of engine breakdown.

The sound receiving element 31 is disposed at the control module 3. The sound receiving element 31 is used to convert surrounding acoustic waves 4 to acoustic analog signals, and transmits the acoustic analog signals to the analog-to-digital converter 23 of the hand-held host 2 via the signal wires. The analog-to-digital converter 23 converts the acoustic analog signals to digital signals, and transmits the digital signals to the digital signal processor 25 for comparing the digital signals with the voiceprint data stored in the storage unit 24.

For example, amplitude and waveform of the digital signals and the voiceprint data can be used to compare. If the digital signal is the same as the voiceprint data stored in the storage unit 24, it can be determined as a certain surrounding sound, such as the sound of something breakdown. The digital signal processor 25 makes the comparison result shown at the display 21 of the hand-held host 2.

In an embodiment, the hand-held host 2 further includes a speaker to broadcast the acoustic analog signals after the sound receiving element 31 converting the surrounding acoustic waves 4 to acoustic analog signals. A user can know if something wrong in the object by determining the sound from the speaker, and further to fix the damaged portion. The sound receiving element 31 can be a microphone, and the microphone can be an omnidirectional microphone or a cardioid microphone. It is not limited herein.

Although the present invention has been described in terms of specific exemplary embodiments, it will be appreciated that the embodiments disclosed herein are for illustrative purposes only and various modifications and alterations might be made by those skilled in the art without departing from the spirit and scope of the invention as set forth in the following claims.

What is claimed is:

1. An endoscope with function of acoustic wave detection and voiceprint comparison, comprising:
a flexible tube, one end of the flexible tube having a control module, and a plurality of signal wires are disposed in the flexible tube;
a hand-held host, comprising an analog-to-digital converter, a storage unit and a digital signal processor, and a plurality of voiceprint data are stored in the storage unit; and
a sound receiving element, disposed at the control module to convert surrounding acoustic waves to acoustic analog signals, and transmitting the acoustic analog signals to the hand-held host via the signal wires;
wherein, when the acoustic analog signals are transmitted to the hand-held host, the analog-to-digital converter converting the acoustic analog signals to digital signals and transmitting the digital signals to the digital signal processor for comparing the digital signals with the voiceprint data stored in the storage unit.

2. The endoscope according to claim 1, wherein the control module further comprises an image-capturing element and a plurality of light-emitting elements, and image data and control signals from the image-capturing element are transmitted by the signal wires.

3. The endoscope according to claim 2, wherein the light-emitting element is light-emitting diode (LED).

4. The endoscope according to claim 2, wherein the image-capturing element is a sensor of CCD or CMOS corresponding to optics lens for getting the image data.

5. The endoscope according to claim 1, wherein the sound receiving element is a microphone.

6. The endoscope according to claim 5, wherein the microphone is an omnidirectional microphone or a cardioid microphone.

7. The endoscope according to claim 1, wherein the hand-held host further comprising a display, buttons, two communication interface ports, and a memory slot.

8. The endoscope according to claim 7, wherein the display showing a comparison result from comparing the digital signals with the voiceprint data stored in the storage unit by the digital signal processor.

9. The endoscope according to claim 1, wherein the hand-held host further comprising a speaker to broadcast the acoustic analog signals.
